(19) United States
(12) Patent Application Publication
(10) Pub. No.: US 2015/0090712 A1
(43) Pub. Date: Apr. 2, 2015

(54) FRACTIONALLY PROPORTIONED, NESTING CONTAINER BOTTLES, WITH JOINING AND CARRYING MEANS

(71) Applicant: Cynthia Washington, Stone Mountain, GA (US)

(72) Inventors: Cynthia Washington, Stone Mountain, GA (US); Aaron Gardner, Atiarta, GA (US); Rashaad White, Stone Mountain, GA (US); Donald Blair, Atlanta, GA (US)

(21) Appl. No.: 14/040,723

(22) Filed: Sep. 29, 2013

(51) Int. Cl. B65D 21/02; G09F 3/00; B65D 41/04

(52) U.S. Cl. CPC B65D 21/0205; B65D 41/04; G09F 3/00; G09F 2003/0272
USPC 220/23.4; 220/288; 220/669; 206/459.5; 220/23.83

(57) ABSTRACT

The current invention comprises fractionally proportioned, nesting containers with a banded, carrying element. Said containers hold liquids, such as carbonated soft drinks, alcoholic beverages, teas, water, etc., in addition to non-liquid goods, ranging from dry recipe ingredients to personal hygiene products. The individual bottles can be manufactured out of glass, metals, alloys and various plastics and sizes of the individual bottles, in the nested unit, are not limited. Container contents determine the fractional proportions of unit and bottle sizes therewith. Said unit accommodates the end user with prepackaged quantities of contents. The configuration of the current invention, permits the end user(s) desiring the same product, within the bottles of said unit, the option to open them separately, in order to sustain freshness of unopened portion(s), further allowing end user to exercise a level of control with regards to amount of product consumption and variety of the contents thereof.

### STATEMENT REGARDING FEDERALLY SPONSORED RESEARCH OR DEVELOPMENT

This invention was made without Government support. The inventor retains all rights to this invention.

### CROSS-REFERENCE TO RELATED APPLICATIONS

This application for the present invention, cross-references U.S. patent application Ser. No. 29/452,105.

### REFERENCE TO SEQUENCE LISTING, A TABLE, OR A COMPUTER PROGRAM LISTING COMPACT DISK APPENDIX

Not Applicable.

### FIELD OF THE INVENTION

It is an object of the current invention to provide the end user with a solution to maximize the retention of carbonation in their soft drink beverage, thus fully enjoying the carbonation retention of said beverage after first opening, in addition to adding convenience and versatility in the flavor mixing and the transporting of said beverage(s). As a consumer, I was frustrated with buying large sized carbonated soft drinks and having them lose the carbonated fizz, before they were finished. In mixing different flavors, I did not like buying so many large sized soda bottles. I started experimenting with different drink combinations of carbonated soft drinks, lemonades, teas and juices. I took notes on how much of the beverage was consumed and how the bottles retained the fresh tastes of the beverage. I noticed in particular, that the unused portions of the carbonated soft drinks always went flat after a day or so and usually immediately, if the top was left off. I concluded that smaller portions and thus smaller container sizes would minimize the loss of carbonation, once a bottle had been opened. Additionally the divided bottle will provide for the opportunity to mix different flavors. In developing the present invention I kept in mind that end users will still be able to get the same amount of beverage, in which they are accustom to purchasing, yet with more control of the rate of consumption, given the fact that the product will remain fresher longer. It will also give the end user a multitude of flavor mixing options. A novel approach to soft drink beverage bottle configurations, as with the present invention, demands an equally novel solution to early and transport said bottles, inspiring a compatible JOINING AND CARRYING MEANS for the individual sections of the FRACTIONALLY PROPORTIONED, NESTING CONTAINER BOTTLES.

### BACKGROUND/DISCUSSION OF RELATED ART

Similar patents are composed of separate bottle sections, however they also combine the liquids upon dispensing out of the respective containers. The function of the current invention is to keep the liquid beverages separate, for the purpose of keeping the unused portion fresh, in addition to mixing different types of beverages. Therefore, each individual bottle opening is independent of the other, with enough clearance between the two bottle openings, to allow the comfortable gripping and twisting of the bottle cap(s), while the bottles are nested and joined. The following related art is listed to provide a contrast to the present invention and outlines how the FRACTIONALLY PROPORTIONED, NESTING CONTAINER BOTTLES, WITH JOINING AND CARRYING MEANS overcome said related art:

With regards to the FRACTIONALLY PROPORTIONED, NESTING CONTAINER BOTTLES:
International Application No.: PCT/U2003/024962, combines two liquids with said liquids being that of a type of cleaning solution.
International Application No.: PCT/AT2005/000505, is comprised of two partial containers which together form a bottle shaped container.
Korean Patent No.: Int C1 B65D 25/00 (2006.01), utilizes a base element to combine both halves of the container which hold liquids separately and dispenses them from a cap with a lid with two openings.
U.S. Pat. No.: 7,258,251 B2, is comprised of two curvilinear shaped half bottle sections, joined on a flat surface of each of the individual sections. There is one cap for the bottle design with separate openings in the cap.
U.S. Pat. No.: 7,946,452 B2, is a bottle design having multiple sections that can be combined to accommodate liquids in various proportions. A single cap combines all of the bottle sections when they are combined.
United States Patent Application Publication No.: US 2005/010381 AI, is a bottle design which combines multiple bottle sections and bottle opening is designed to prevent return flow of the discharged substance and also permits the admission of air into the product chamber.
United States Patent Application Publication No.: US 2006/0021996 AI, is comprised of a bottle design that has separate sections which combine in a single cap, while dispensing liquids. One of the embodiments in the design has a novelty component.
United States Patent Application Publication No.: US 2010/0116768 AI, relates to a bottle having triple chambers for separately dispensing liquids.
United States Patent Application Publication No.: US 2010/0237034 AI, provides a bottle having a dividing wall.
With regards to the JOINING AND CARRYING MEANS:
United States Patent Application Publication No.: U.S. Pat. No. 2,464,069—This patent utilizes straps to hold the interior bottle.
United States Patent Application Publication No.: U.S. Pat. No. 4,372,598—In each of the embodiments of this patent the bottle neck receiving openings are defined by various arrangements of hollow cylindrical segments.
United States Patent Application Publication No.: U.S. Pat. No. 4,634,002—In this patent a plurality of container supporting tabs project upwards from the upper ring in order to retain ach container by its neck.
United States Patent Application Publication No.: U.S. Pat. No. 5,096,246—The bottle carrier in this patent is designed to carry standard full sized bottles.
United States Patent Application Publication No.: U.S. Pat. No. 5,199,562—The carrier that supports the bottles around the neck region of the bottles in this design also have a defined area for grip handling.
United States Patent Application Publication No.: U.S. Pat. No. 5,290,083—This patent design is formed from a generally flat rectangular sheet of resilient material.
United States Patent Application Publication No.: U.S. Pat. No. 6,334,531—The bottle carrier in this patent design is of two pieces consisting of the carrier itself with a slot that accommodates the handle region.
United States Patent Application Publication No.: U.S. Pat. No. 6,658,815—The bottle carrier system is designed for enabling a user to quickly and easily divide bottled beverages into six packs.
United States Patent Application Publication No.: U.S. Pat. No. 6,715,810—Has support rings that can carry three bottles around the bottles neck region.
United States Patent Application Publication No.: U.S. Pat. No. 6,789,828—This patent design is for balanced lifting and carrying of two bottles by their necks and that maintains a space between the bottles to prevent collisions between them.

### BRIEF DESCRIPTION OF DRAWINGS

FIG. 1 is a perspective view of the two bottles of the current, shown while they are separated.

FIG. 2. is a perspective view of the two bottles of the current invention, shown while they are nesting.

FIG. 3. is a top ¾ perspective view of the flat nesting side of one bottle of the current invention, showing also the top angled section.

FIG. 4 is a ¾ profile view of the curvilinear surface of the current invention laying on a flat surface.

FIG. 5 is a bottom profile view of one bottle of the current invention.

FIG. 6 is a top profile view of one bottle without a removable twist cap, of the current invention.

FIG. 7.a is a side profile view of one bottle of the current invention.

FIG. 7.b is a side profile view of one bottle of the current invention with a label wrap.

FIG. 8 is a side profile view of two bottles of the current invention, shown with a packaging wrap joining both bottles and a perforated region therewith.

FIG. 9 is a front profile view of the top section of one of the bottles of the current invention showing the threads, which accommodate a removable twist cap.

FIG. 10 is a front profile view of one bottle of the current invention, showing the curvilinear section of the bottle design.

FIG. 11 is a back profile view of one bottle of the current invention, showing the flat nesting lower surface and the angled upper surface of the bottle design

FIG. 12 is a side profile view of two bottles of the current invention, shown with a packaging wrap joining both bottles and a perforated region therewith, in addition to a banded joining and carrying means.

FIG. 13 is a banded joining and carrying means for the current invention.

### DETAILED DESCRIPTION OF THE INVENTION AND THE PREFERRED EMBODIMENT

It will be readily understood that the components of the present invention, as generally described and illustrated in the Figures herein, may be arranged and designed in a wide variety of different configurations. Thus, the following more detailed description of embodiments of the present invention, as represented in the Figures is not intended to limit the scope of the invention, as claimed, but is merely representative of a selected embodiment of the invention. The illustrated embodiment of the invention will best be understood by reference to the drawings, wherein like parts are designated by like numerals throughout. Those of ordinary skill in the art will, of course, appreciate that various modifications to the methods described herein, which can easily be made without departing from the essential characteristics of the invention, as described in connection with the Figures. Thus, the following description of the Figures is intended only by way of example, and simply illustrates a certain selected embodiment consistent with the invention as claimed herein;

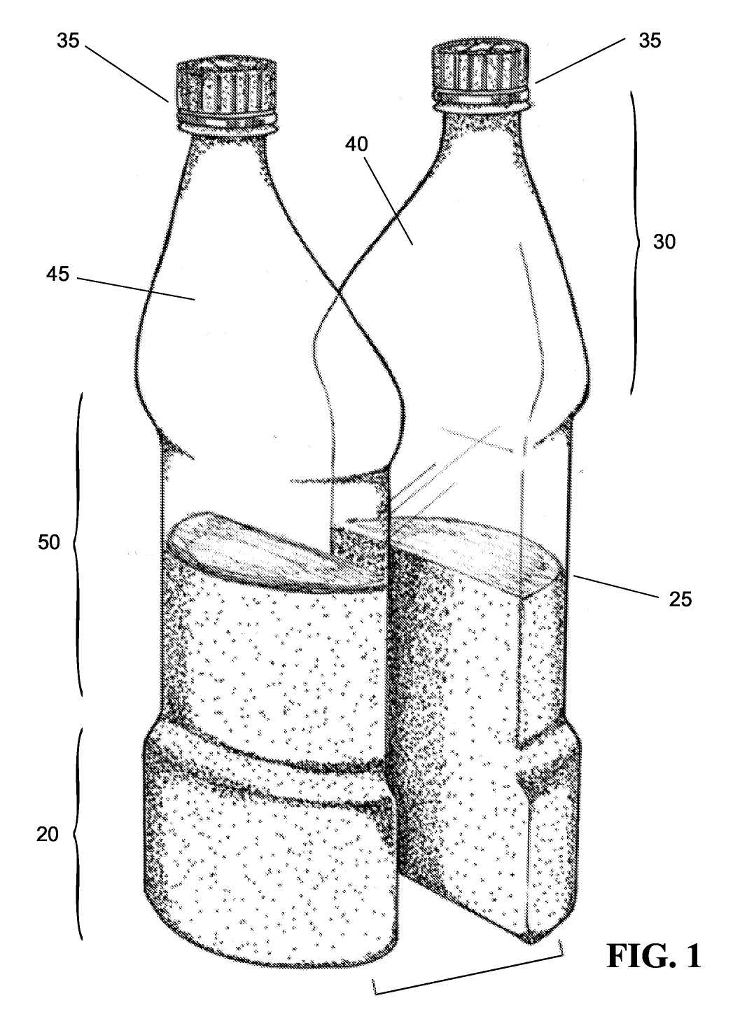

Referring now to the invention in more detail, FIG. 1 shows a perspective view of the current invention with 20) lower section of bottle, 25) Indented Curvilinear surface, 30) Upper section of bottle, 35) Removable twist cap, 40) Flat upper, angled surface, 45) Upper section of the bottle, 50) Middle section of bottle.

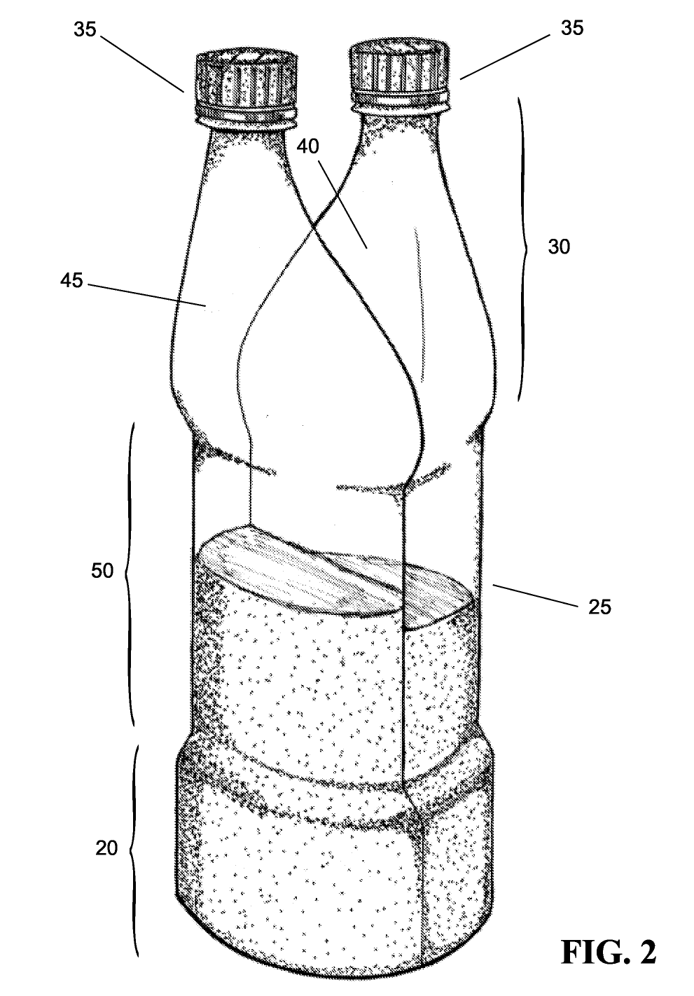

Referring now to FIG. 2, shows a perspective view of the current invention with 20) lower section of bottle, 25) indented Curvilinear surface, 30) Upper section of bottle, 35) Removable twist cap, 40) Flat upper, angled surface, 45) Upper section of the bottle, 50) Middle section of bottle.

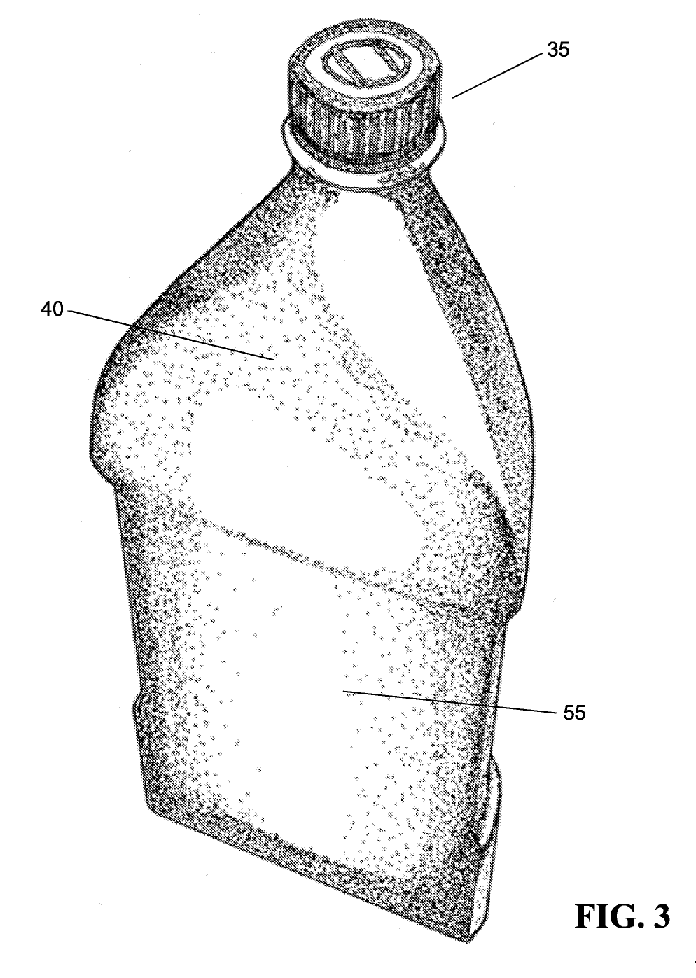

In further detail, FIG. 3, there is shown a top perspective view of the current invention with 35) Removable twist cap, 40) Flat upper, angled surface, 55) Flat nesting surface.

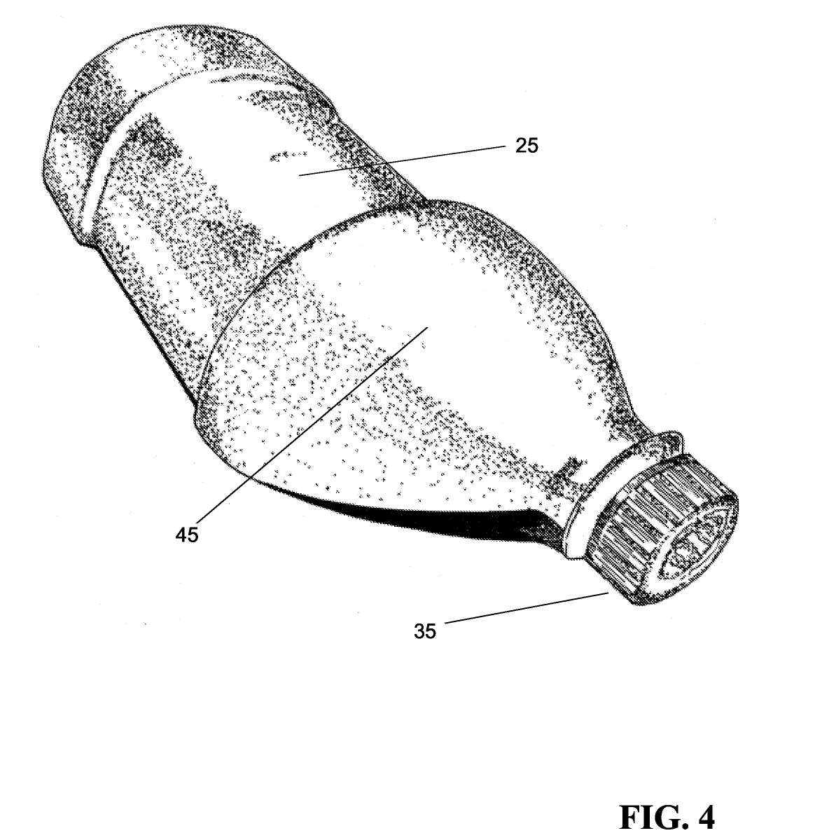

Referring now to FIG. 4, there is shown a perspective view of the current. invention with 25) Indented Curvilinear surface, 35) Removable twist cap, 45) Upper section of the bottle.

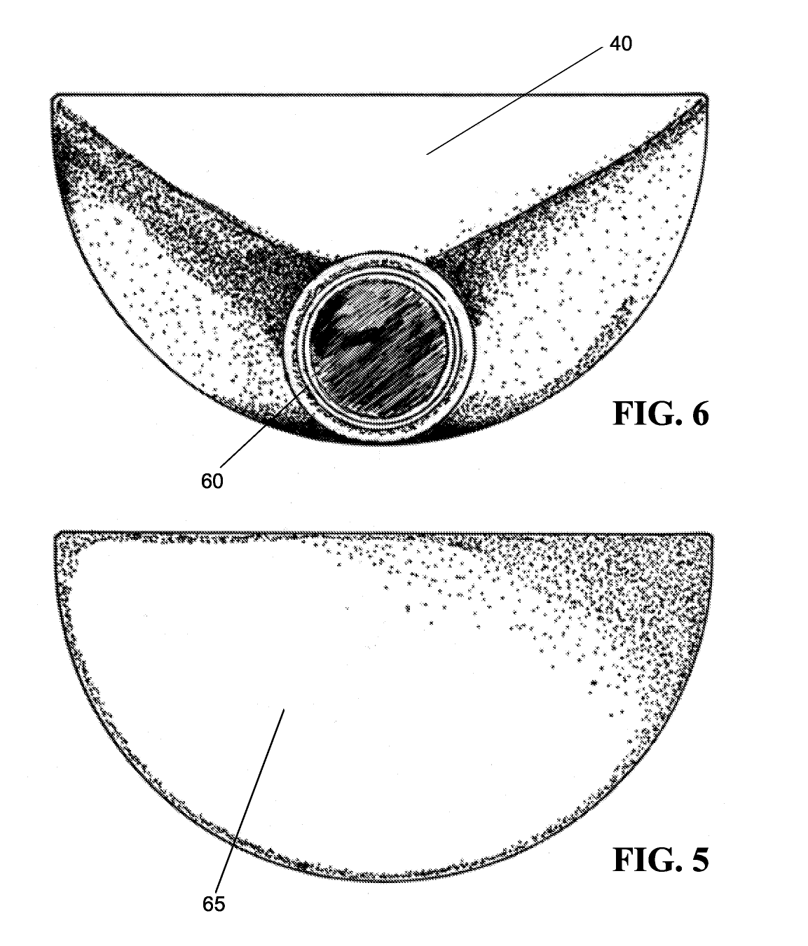

Referring now to FIG. 5, there is shown a bottom profile view 65) Base surface.

Referring now to FIG. 6, there is shown a top profile view 40) Flat upper, angled surface, 60) Neck region of bottle.

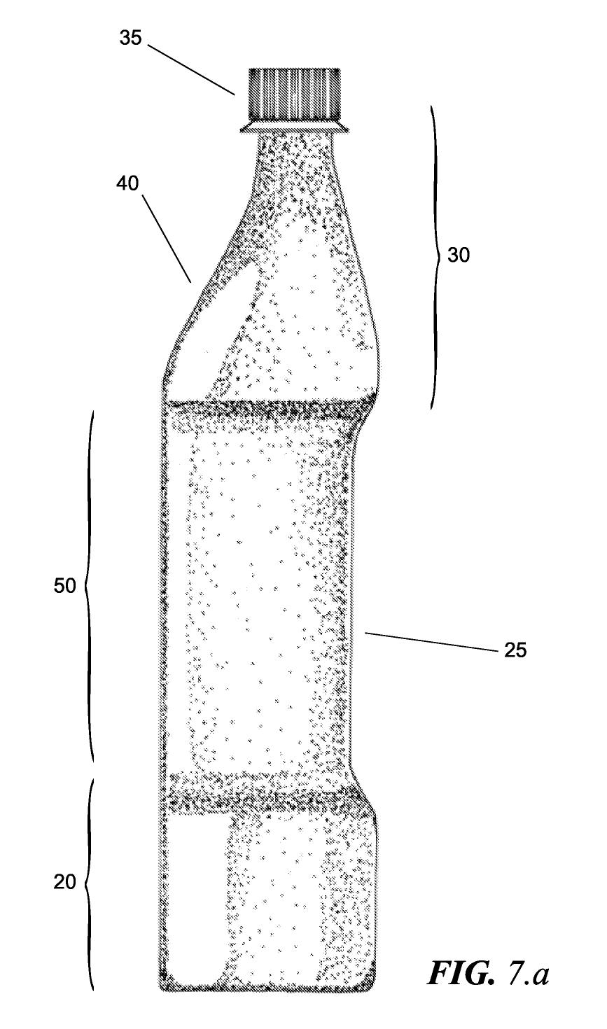

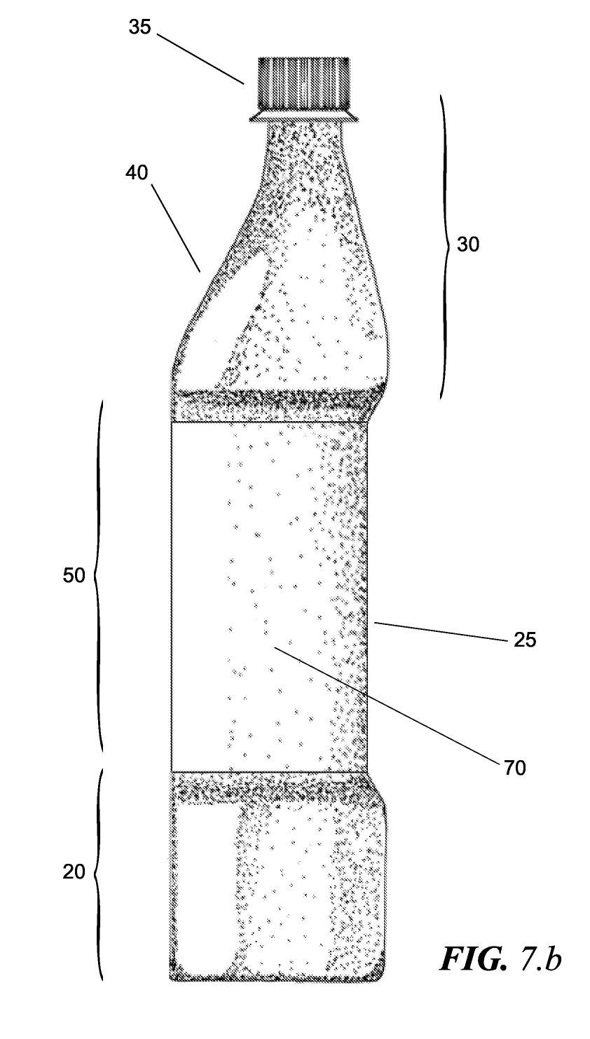

Referring now to FIG. 7, there is shown a side profile view of one bottle of the current invention with 20) Lower section of bottle, 25) Indented Curvilinear surface, 30) Upper section of bottle, 35) Removable twist cap, 40) Flat upper, angled surface, 50) Middle section of bottle.

Referring now to FIG. 7.b, there is shown a side profile view of one bottle of the current invention with 20) Lower section of bottle, 25) Indented Curvilinear surface, 30) Upper section of bottle, 35) Removable twist cap, 40) Flat upper, angled surface, 45) Upper section of the bottle, 50) Middle section of bottle.

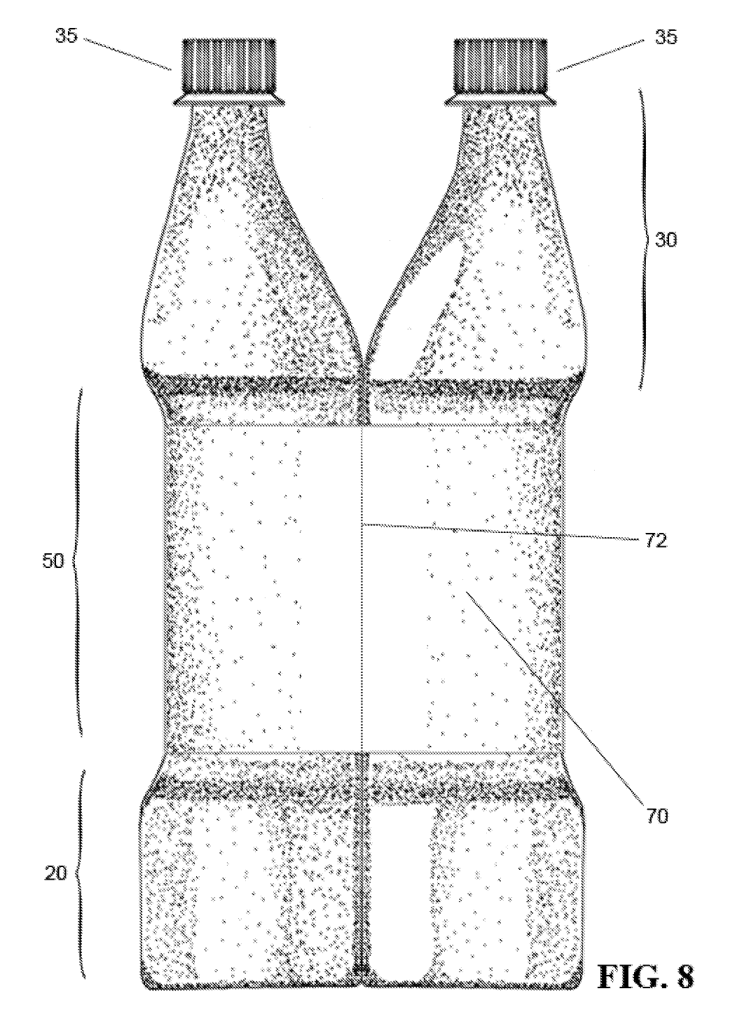

Referring now to FIG. 8, there is shown a two bottle unit side profile view of the current invention with 20) Lower section(s) of bottle(s), 30) Upper section(s) of bottle(s), 35) Removable twist cap (s), 50) Middle section(s) of bottle(s), 70) Unit Package wrap, 72) perforation to separate individual bottles.

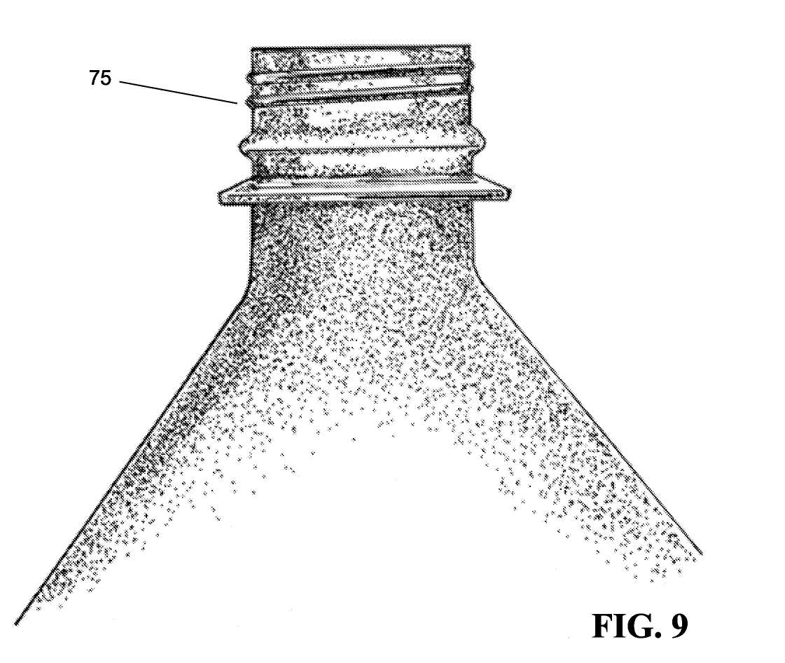

Referring now to FIG. 9, there is shown a side profile view of the current invention with 75) Interior threaded neck region.

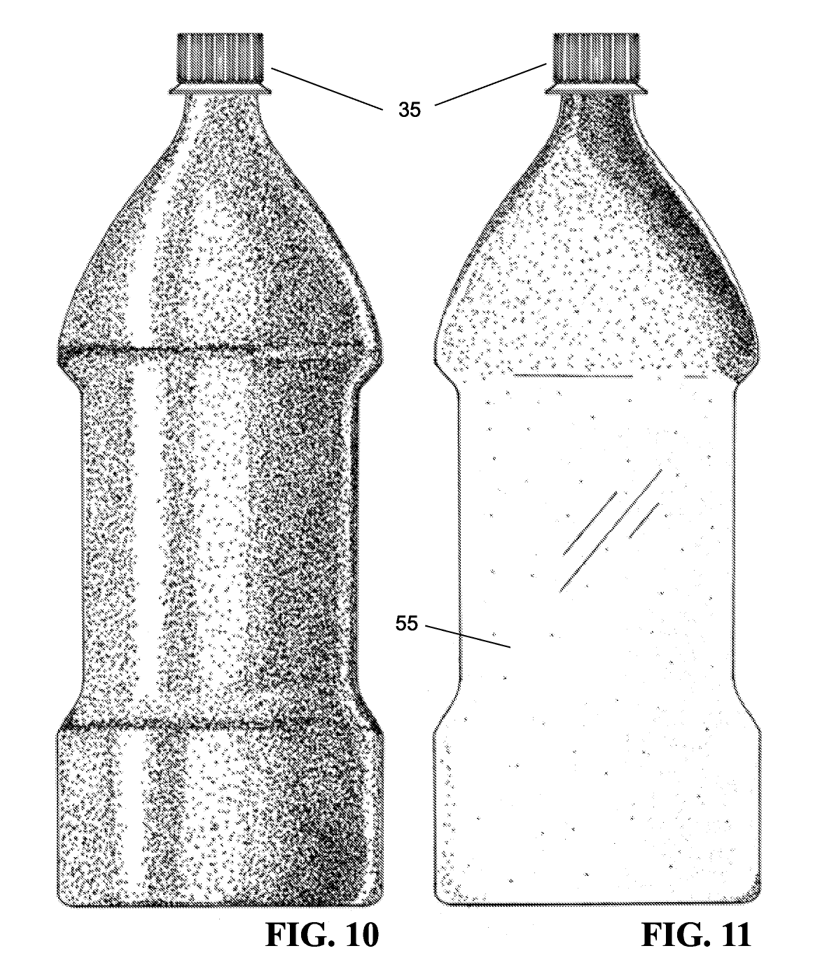

Referring now to FIG. 10, there is shown a front profile view of the current invention with 35) Removable twist cap.

Referring now to FIG. 11, there is shown a front profile view of the current

invention with 35) Removable twist cap, 55) Flat nesting surface.

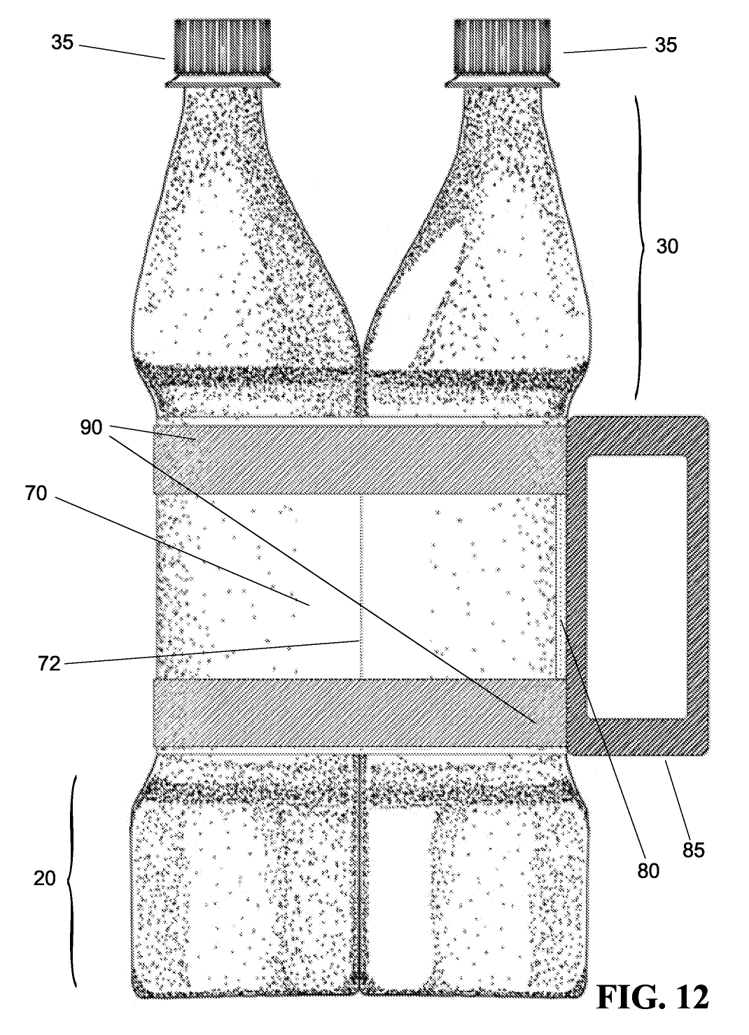

Referring now to the invention in more detail, FIG. 12, there is shown a two bottle unit, side profile view of the current invention with 20) Lower section(s) of bottle(s), 30) Upper section(s) of bottle(s), 35) Removable twist cap (s), 50) Middle section(s) of bottle(s), 70) Unit Package wrap, 72) perforation to separate individual bottles, 80) joining means, 85) carrying means, 90) full circumference joining band(s).

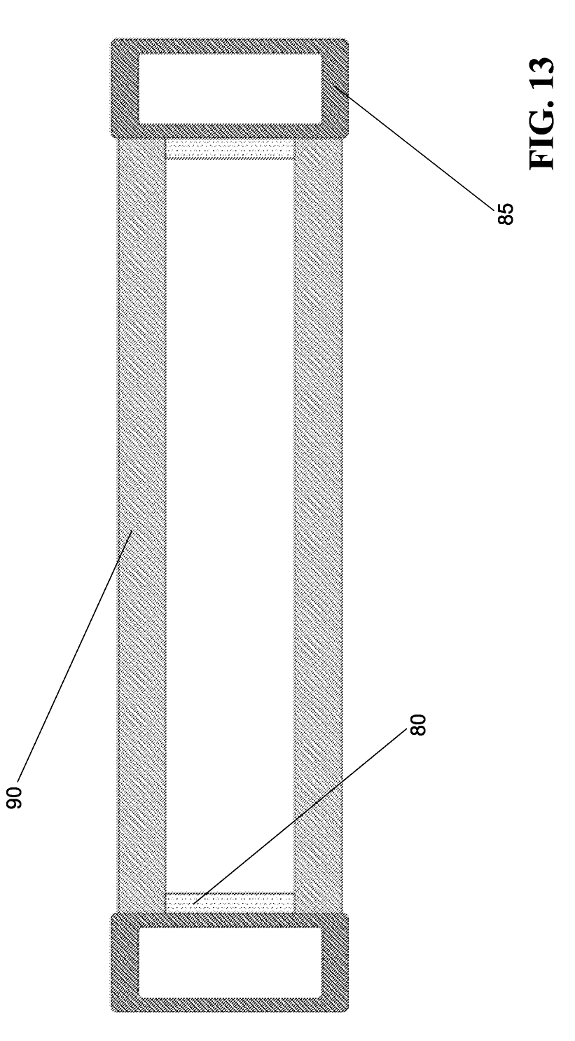

Referring now to the invention in more detail, FIG. 13, there is shown a profile view of the joining and carrying means. The joining and carrying means wrap around the circumference of the individual nested bottle unit sections. The thickness of the joining and carrying means is negligible due to the nature of its flat design with a joining section accommodating an adhesion element, full circumference bands which wrap around and secure the individual bottle sections and a carrying means which can lay flat against the bottle surface when not in use and further allow for ease in transporting the individual nested bottles as a unit. The joining and carrying means comprises 80) joining means, 85) carrying means, 90) full circumference joining band(s).

The advantages of the present invention comprise, without limitation, bottles manufactured in commonly used sizes of beverage containers that can be configured in multiple units. Said bottles are able to stand upright or lay on a flat surface. In broad embodiment, the invention should therefore not be limited by the above described embodiment, method, and examples, but by all embodiments and methods within the scope and spirit of the invention as claimed.

### METHODS OF USE

A common staple in almost every American household is the two-liter soft drink beverage container. Two-liter bottles were first introduced in 1970 and by 1985, a three liter bottle appeared on store shelves. The basic design is still used by some bottlers. Most bottles are produced from a plastic known as PET or polyethylene terephthalate. These containers are blow molded, with a re-sealable screw-cap and the labels affixed are of a tight fitted plastic sleeve. Due to the fact that America uses primarily the English system of measurement, two-liter bottles are one of the few instances of a product being sold in metric units. Other common metric sizes for plastic soft drink bottles include 3 liters, 1 liter and 500 milliliters. Other countries, such as Russia, use plastic bottles for not only soft drinks but for also selling beer.

The stylized functional design of the current invention is an improved container that gives bottlers the potential to market their beverages in a single container or multiple units. With the common soft drink beverage unit sizes of 500 milliliters, 1 liter, 2 liter and 3 liters, bottlers can have the advantage of offering multiple units of a given size, in order to give consumers more purchasing options. For example two 500 milliliter bottles can be sold as a unit to make 1 liter and two 1 liter bottles can be sold together as a two liter unit and so forth. This provides the familiarity of quantities that consumers are accustom to while offering options of variety in their beverage purchases.

Furthermore, the current invention enables the end user/consumer to pour from the bottle(s) individually or simultaneously, retain carbonation in the soft drink beverage by only opening the portion of the unit being consumed, in addition to the potential to consume multiple flavors from different bottles in the unit with a specially designed straw.

Finally, the present disclosure may be constructed by any manufacturing means. For example, blow molding technology may be utilized. A plurality of different types of materials, including thermoplastic resins may be utilized in any type of form or blow molding techniques.

The invention claimed is:

1. A single or plurality of container(s) each individually comprising;
(a) an outlet aperture, a base surface, interior wall region, exterior wall region, a sidewall joining the base and aperture, indented curvilinear surface, lower section, mid-section, upper section, flat upper angled surface, flat exterior wall nesting surface, a bottle neck region,
(b) female threaded twist cap screwably affixed to a male threaded portion of the external portion of the bottle neck region.

2. The ergonomically designed indented curvilinear surface of the container of claim 1, which enables users of the current invention to handle said container.

3. The base surface of the container of claim 1 constructed with a means to allow said container o stand upright in a balanced fashion.

4. Materials used in the manufacture of the container according to claim 1 whereby said materials permits the containment of liquid or non-liquid elements.

5. A manufacturing means, enabling variance of size of the container according to claim 1.

6. A labeling means for the container of claim 1 comprising ink printed directly on container or ink printed on a separate sleeve wrap affixed to said container.

7. A packaging means for the plurality of containers according to claim 1, comprising ink printed on a separate sleeve wrap, affixed to said containers, with a perforated region designed to assist in the separation of said containers from the unit of multiple nested container sections.

8. A plurality of containers according to claim 1, each bottle having an exterior wall and a bottom wall which cooperates to define a chamber therein, wherein at least a portion of the exterior wall is adapted to nest with at least a portion of an exterior wall region of another bottle.

9. A plurality of containers according to claim 1, viewed from a top profile correspond to fractional divisions of a circle. Two bottles on a center axis are divided with a single exterior nesting wall surface forming a 180 degree line, three bottles each with exterior nesting wall surface angles of 60 degrees, four bottles with individual exterior nesting wall surface angles of 90 degrees.

10. A flat rectangular joining and carrying element for the containers of the current invention, composed of two smaller rectangles incorporated on either end, whose long sides (length) are equal to the short side (height) of the larger rectangle, whereby either end has slightly radioed edges, accommodating the joining of such smaller rectangles by folding over, forming a handle portion thereof, in addition to a joining portion therein, and further used in the binding and transport of the containers of the current invention.

11. A disposable or recyclable, pliable material used in the construction of the joining and carrying element in claim 10.

12. An adhesion means applied to a section of the joining and carrying element of claim 10, whereby said means creates a permanent or semi-permanent adhesion of said element folded over, joining the end rectangular regions.
